(19) United States
(12) Patent Application Publication
(10) Pub. No.: US 2003/0107711 A1
(43) Pub. Date: Jun. 12, 2003

(54) AN ILLUMINATION METHOD AND APPARATUS FOR PROJECTION SYSTEM

(76) Inventor: Sze-Ke Wang, Hsin-Chu City (TW)

(21) Appl. No.: 10/065,952

(22) Filed: Dec. 3, 2002

(30) Foreign Application Priority Data
Dec. 6, 2001 (TW) 090130582

(51) Int. Cl. G03B 21/00

(52) U.S. Cl. 353/31

(57) ABSTRACT

### Abstract of Disclosure

The present invention mainly includes an illumination system and an imaging system, wherein the illumination system generates an incident light beam, and, by means of reflection with a reflecting lens, projects it from above in front of the field lens, into the first surface of the field lens fronting the projection lens set, then through the field lens, and onto the light valve of the imaging system, wherein the geometric center of the light valve is located at the underside of the optical axis of the second surface adjacent to the corresponding side of the first surface of the field lens, allowing the geometric center of the transmissive area created by the projection of the light beam into the field lens to be much closer to the optical axis of the field lens than the geometric center of the light valve is, thus ensuring that the transmissive area is contained within the optimized area on the field lens, while reducing the amount of distortion generated in the light spot by the light beam coming in through the field lens, wherein the said light beam is then further reflected, by means of reflection with the array of micro-mirrors poised on the light valve to differentiate the angles of reflection at ON-state or OFF-state, through the field lens, then into or away from the projection lens set, and is selectively projected onto the screen, so as to improve illumination efficiency, while lowering the cost and reducing the volume.

### Background of Invention

1.Field of the Invention

The present invention relates to a projection system, and more particularly, to an illumination method and apparatus for the projection system.

2.Descriptions of the Prior Art

There have been many significant achievements accomplished in every branch of the hi-tech industries in recent years. Developments in the field of optical-electronics have been particularly rapid. Digitalized electronic components, such as digital micro-mirror device (DMD) as a light valve are gradually applied in projection systems which require light weight, slimness, and compactness. The light valve consists of an array of inclinable pixel mirrors with a diagonal rotation within an angle range of ±12°. When the inclinable pixel mirrors reflect an incident beam onto an screen, this is referred to as an ON-state; when they reflect an incident beam away from the screen, this is referred to as an OFF-state; when they parallel the plate of the light valve, this is referred to as a Flat-state.

The mechanism of the light valve applied in the projection system 10 of a prior art is illustrated in FIG. 1.The projection system 10 consists of an illumination system 20 and an imaging system 40, wherein the illumination system 20 includes a light source 21, a color wheel 22, an integrated rod 23, an illumination lens set 24, a field lens 30, and a reflecting mirror 25.And the imaging system 40 includes the field lens 30 shared out as mentioned above, a light valve 41, a projection lens set 42, and a screen 43. The path of the projection starts with a light beam emitted from the light source 21, being, firstly, filtered by the color wheel 22 to become light beams of primary colors such as red, blue, and green. The light beams are then uniformed by the integrated rod 23, and are projected into the illumination lens set 24, wherein the light beams are converged and projected on the reflecting mirror 25.The light beam changes its incident direction by means of the reflecting mirror 25, and projects at the lower right of the field lens 30, wherein the field lens 30 then further refracts the light beam onto the light valve 41 of the imaging system 40. By means of the ON-state or OFF-state of the inclinable pixel mirrors, the light valve 41selectively reflects the beam through the field lens 30 into the projection lens set 42, and, finally, onto the screen 43.

However, in this kind of projection system 10 of the prior art, as illustrated in FIG. 2-1, the light beam emitted from the light source 21 is rigidly confined due to the limited diagonal rotation angle at which the micro-pixel mirrors are poised on the light valve 41, wherein the light beam usually reflected from the reflecting mirror 25 positioned at lower right front of the field lens 30 obliquely impinges on the transmissive area 31 located at lower right of the field lens 30, then through the field lens 30, and finally onto the light valve 41. If viewed from the arrow A, as illustrated in FIG. 2-2, the transmissive area 31 is located farther from the optical axis C of the field lens 30 than the light valve 41 is, and rather close to the edge of the field lens 30.Therefore, as illustrated in FIG. 2-3, this oblique incidence to the light valve causes distortion of the light spot 412,shown as dotted lines. Thus the light spot 412fails to cover the whole surface of the light valve 41, and that results in the light valve 41 being unable to reflect and display the whole image. For this reason, in order to enable the light spot 412 to cover the whole surface of the light valve 41, as illustrated in FIG. 2-4, the method adapted for the projection system 10 of the prior art is to increase the cross-section of the light beam, then the light spot 412 is enlarged and turn into a large light spot 413, in order to cover the whole surface of the light valve 41. Although such a method may solve the above-mentioned problem of incomplete image projection, some light beams out of the surface of the light valve 41,as the illuminated area 414 shown in the drawing with slanted lines, can't be projected from the light valve 41. Being unable to be reflected by the light valve 41 to enter into the projection lens set 42, such light beams are unable to be projected onto the screen 43, and the overall illumination efficiency of the projection system 10 is lowered because of this loss of illumination. In the meantime, in order to enlarge the light spot 412 into a large light spot 413, the transmissive area 31 is also enlarged beyond the area of the field lens 30, forcing the increase of the diameter of the field lens 30 so as to ensure that all the light beams in the transmissive area 31 are contained on the area of the field lens 30. This not only increases the cost of the field lens, but also the volume of the whole projection system, failing to meet the requirements in terms of light weight, slimness and compactness.

### Summary of Invention

One object of the present invention is to provide an illumination method and apparatus for projection system which can reduce the loss of illumination so as to increase the efficiency of the illumination.

The other object of the present invention is to provide an illumination method and apparatus for projection system which can reduce the volume and lower the cost of the projection system.

To achieve the above mentioned objectives, the present invention mainly comprises an illumination system and an imaging system, wherein the illumination system generates an incident light beam and, by means of reflection with a reflecting lens, projects it from above in front of the field lens into the first surface of the field lens fronting the projection lens set, then through the field lens, and onto the light valve of the imaging system. The geometric center of the light valve is located at the underside of the optical axis of the second surface adjacent to the corresponding side of the first surface of the field lens, allowing the geometric center of the transmissive area created by the projection of the light beam into the field lens to be much closer to the optical axis of the field lens than the geometric center of the light valve is, thus ensuring that the transmissive area is contained within the optimized area on the field lens, and reduces the amount of distortion generated in the light spot by the light beam coming in through the field lens. The light beam is then further reflected, by means of reflection with the array of micro-mirrors poised on the light valve to differentiate the angles of reflection at ON-state or OFF-state, through the field lens, then into or away from the projection lens set, to be selectively projected onto the screen.

### Brief Description of Drawings

FIG. 1 is a schematic view illustrating the top view of the optical structural deployment of the projection system of the prior art.

FIG. 2-1 and FIG. 2-2 are front and side views illustrating the optical path of the incident light beam projected from the field lens and onto the light valve of the projection system of the prior art as shown in FIG. 1.

FIG. 2-3 and FIG. 2-4 are diagrams illustrating the corresponding positions of the light valve and the light spot before and after the correction of the projection system of the prior art.

FIG. 3 is a top view illustrating the optical structural deployment of the projection system of the present invention.

FIG. 4 is a front view illustrating the incident light beam being projected from upper left front of the field lens and onto the light valve of the present invention.

FIG. 5 and FIG. 6 are schematic views illustrating the optical path of the incident light beam being projected from the field lens and onto the light valve of the present invention as shown in FIG. 4.

FIG. 7 is a schematic view illustrating the corresponding positions of the light valve and the light spot of the present invention.

FIG. 8 is a front view illustrating the incident light beam being projected from upper right front of the field lens onto the light valve of the present invention.

FIG. 9 is a front view illustrating the incident light beam projected from upper middle front of the field lens onto the light valve of the present invention.

FIG. 10 is a schematic view illustrating the corresponding positions of the central area on the first surface of the field lens of the present invention.

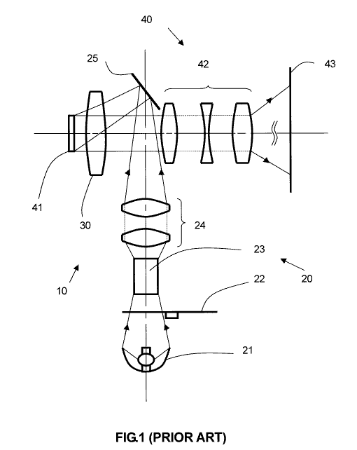

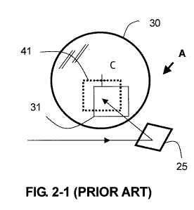

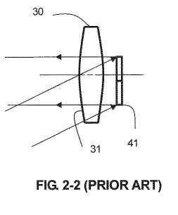

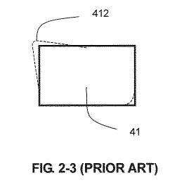

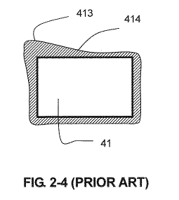

### Detailed Description

An embodiment of the present invention, along with the techniques and methods applied to fulfill the above-mentioned objects and with its effectiveness, will now be described in detail with reference to the drawings.

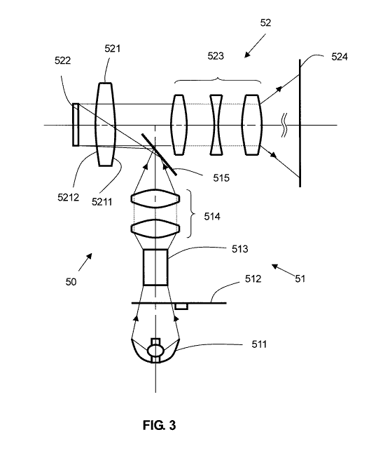

Illustrated in FIG. 3 is a preferred embodiment of the illumination method and apparatus for projection system of the present invention, wherein the projection system 50 includes an illumination system 51 and an imaging system 52, whereby a light beam generated by the illumination system 51 is reflected onto the imaging system 52, and it is then decided by the imaging system 52 whether or not it is to be projected onto the screen 524.

The illumination system 51 includes a light source 511, a color-generating device 512 (such as color wheel, filter), a uniform device 513 (such as integrated rod, lens array), an illumination lens set 514 (such as converge lens, relay lens), a reflecting lens 515 (such as reflecting mirror, prism), and a field lens 521. A light beam is first generated by the light source 511 of the illumination system 51, then goes through the color generating device 512, wherein the light beam is continuously filtered into such primary colors as red, blue, and green, before going further into the uniform device 513, wherein the brightness of the light beam is uniformed. And the light beam is adjusted and converged through the illumination lens set 51 before being projected onto the reflecting lens 515, wherein the light beam reflected by the reflecting lens 515 enters the field lens 521 from upper left front of the field lens 521, forming an illumination system 51.

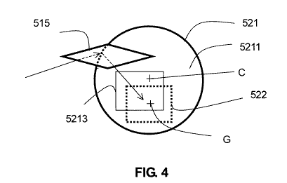

In addition, the imaging system 52 includes a field lens 521, a light valve 522 (such as DMD, or TMA (Thin-film Micro-mirror Array)), a projection lens set 523 and a screen 524, wherein the field lens 521 of the imaging system 52 shares the same field lens 521 with the illumination system 51.The incident light beam from the illumination system 51is projected onto the first surface 5211 of the field lens 521 fronting the projection lens set 523, through the field lens 521, and then onto the light valve 522 of the imaging system 52.Referred to FIG. 4, the geometric center G of the light valve 522 is located at the underside of the optical axis C of the second surface 5212 of the field lens 521 adjacent to the corresponding side of the first surface 5211 of the field lens 521, wherein, by means of the micro-mirror array on the light valve 522, which allows swiveling to differentiate the angles of reflection at ON-state or OFF-state, at ON-state of the light valve 522, the incident light beam is able to enter the projection lens set 523 and, thus, is projected onto the screen 524, whereas, at OFF-state of the light valve 522, the light beam is unable to enter the projection lens set 523, and thus cant be projected onto the screen 524.

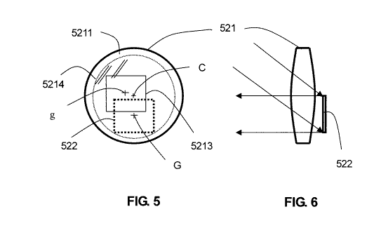

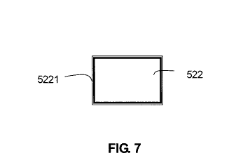

As shown in FIG. 4, the practice of the present invention is to have the incident light beam of the illumination system 51, by means of being reflected from a reflecting lens 515, projected from upper left front of the field lens 521, obliquely into a location near the optical axis C on the first surface 5211 of the field lens 521, through the field lens 521, then onto the light valve 522 adjacent to the second surface 5212 of the field lens 521.As shown in FIG. 5 and FIG. 6, with the light beam impinging obliquely from the top downward through the field lens 521, a transmissive area 5213 being formed on the first surface 5211 of the field lens 521, wherein the transmissive area 5213 is not only located within the optimized area 5214 of the field lens 521, owing to there being little distortion, but also has its geometric center g of the transmissive area 5213 being closer to the optical axis C of the field lens 521, allowing the light spot 5221 formed by the light beam after coming through the field lens 521 not to undergo substantial distortion. Therefore, as illustrated in FIG. 7, as long as the light spot 5221 can be kept slightly larger than the area of the light valve 522, it can be assured that the light spot 5221 can completely cover the light valve 522, allowing the projection reflected by the light valve 522 to stay as a whole, whereupon the part of the light spot 5221 lost outside the light valve area 521 becomes smaller, thus improving the illumination efficiency of the projection system 50. In the meantime, with the geometric center g of the transmissive area 5213 being closer to the optical axis C of the field lens 521 than the geometric center G of the light valve 522, as long as the position of the light valve 522 is kept within the optimized area 5214 of the field lens 521, the transmissive area 5213 will not go beyond the optimized area 5214 of the field lens 521; thus, major distortion in the illuminated area 5221 can be avoided. Therefore, adjusting the position of the light valve 522 by moving it closer to the optical axis C of the field lens 521 will be able to reduce the diameter of the field lens 521, thus not only lowering the cost needed for expensive optical components, but also reducing the volume of the whole projection system 50 to such an extent that it can meet the requirements of weight lightness, slimness, and compactness.

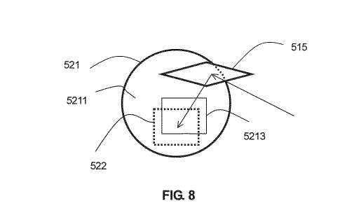

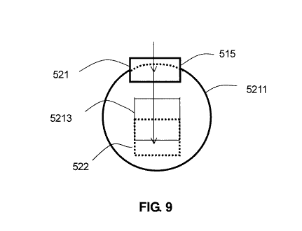

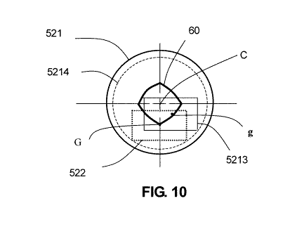

The method of the present invention further includes other methods than the one mentioned above, wherein the incident light beam projects from upper left front of the first surface 5211 of the field lens 521, obliquely beaming through the field lens 521 and onto the light valve 522. As illustrated in FIG. 8 and FIG. 9, methods can be any that is rendered in such a way that it can be coordinated with the angles or direction by which the pixel lens array is poised on the light valve 522, or be coordinated with the way the light valve 522 is positioned; wherein the light beam of the illumination system 51 can also be reflected by the reflecting lens 515 positioned at up front above or upper right above the field lens, or from up front above or upper right above the spot corresponding to the location of the light valve 522 on the first surface 5211 of the field lens 521, then obliquely projecting through the field lens 521, and then onto the light valve 522 positioned underneath the optical axis C on the second surface 5212 adjacent to the field lens 521; that is to say, as long as the light beam can be obliquely projected properly from upper front of the first surface 5211 of the field lens 521, through the field lens 521, and onto the light valve 522, the objectives of the present invention can also be achieved just as well. In addition, as illustrated in FIG. 10, when the incident light beam goes obliquely from top downward through the field lens 521, it creates a transmissive area 5213 on the first surface 5211 of the field lens 521, while allowing the optical axis g of the transmissive area 5213 to be confined within the central area 60, wherein the range of said central area 60 is formed when the distance from the four corners of the central area 60 to the optical axis C is equal to the distance from the geometric center G of the light valve 522 to the optical axis C, and when the arc curvature of the four sides of the central area 60 is equal to the curvature of the optimized area 5214 on the field lens 521, whereupon the geometric center g of the transmissive area 5213 ends up being closer to the optical axis C of the field lens 521 than the geometric center G of the light valve 522 is, thus ensuring that the transmissive area 5213 is located within the optimized area 5214 of the field lens 521 where the amount of distortion is smaller, and allowing illuminated area 5221, formed after the light beam gets through the field lens 521, to undergo a smaller amount of distortion; such a method can also reduce the area of light spot that is lost outside of the illuminated area 5221, while improving the illumination efficiency of the projection system 50, and reducing the diameter of the field lens 521, so that the volume of the projection system can also be reduced.

What is described above is to facilitate the description of the preferred embodiments of the present invention; the present invention is not limited to the above-mentioned embodiments. Any variations made according to the invention in any way to the details of the present invention may be possible as needed without departing from the scope of the invention. For instance, when allowed by the position of the light beam, instead of using a reflecting lens 515, it is possible to directly project an incident beam from above the field lens 521, through the field lens 521 and onto the light valve 522. Additionally, the illumination method and apparatus for projection system of the present invention project the incident illumination beam reflected from a reflecting lens, from above the field lens, and onto the light valve; this not only improves the illumination efficiency, but also reduces the diameter of the field lens, lowering costs, and trimming down the volume, hence meeting the requirements of lightness, slimness, and compactness.

Claims

1. An illumination method for projection system, wherein the said projection system comprising:
an illumination system, including a light source and a field lens, wherein the light source generates a light beam; and
an imaging system, including a light valve and the field lens, wherein the field lens is provided with an optical axis, a first surface and a second surface located at the corresponding side of the said first surface,the light valve adjacent to the second surface, and the geometric center of the light valve located lower than theoptical axis;
wherein the illumination method obliquely projects from the top downward the lighting beam, from above in front of the first surface, through the field lens, and onto the light valve.

2. The illumination method for projection system according to Claim 1, wherein the abovefront of the first surface includes straight up above, upper left above, and upper right above.

3. The illumination method for projection system according to Claim 1, wherein the illumination system has a reflecting lens set up front of the first surface, allowing the light beam to be reflected onto the first surface.

4. The illumination method for projection system according to Claim 1, wherein the light beam, when projecting through the field lens, forms a transmissive area on the first surface, the geometric center of the transmissive area being located in a central area, with the distance from the four corners of the central area to the optical axis being equal to the distance from the geometric center of the light valve to the optical axis, and the arc curvature of the four sides of the central area being equal to the curvature of the optimized area on the field lens.

5. An illumination apparatus for projection system, comprising an imaging system and a illumination system:
wherein the imaging system, including:
a field lens, being provided with an optical axis, a first surface and a second surface on corresponding side; and
a light valve, being set up adjacent to the second surface of the field lens, whereof the geometric center of the light valve is located lower than the optical axis; and
wherein the illumination system, including:
a light source, generating a light beam, which obliquely projects from the top downward the light beam, from above in front of the first surface, through the field lens, and onto the light valve,
6. The illumination apparatus for projection system according to Claim 5, wherein the illumination system has a reflecting lens set up in front of the first surface, allowing the light beam to be reflected, from the first surface, by means of the reflecting lens, onto the light valve.

6. 7. The illumination apparatus for projection system according to Claim 6, wherein the reflecting lens is a prism.

7. 8. The illumination apparatus for projection system according to Claim 5, wherein the light beam, when projecting through the field lens, forms a transmissive area on the first surface, the geometric center of the transmissive area being located in a central area, the distance from the four corners of the central area to the optical axis being equal to the distance from the geometric center of the light valve to the optical axis, and the arc curvature of the four sides of the central area being equal to the curvature of the optimized area on the field lens.

8. 9. The illumination apparatus for projection system according to Claim 5, wherein the illumination system includes a color-generating device, a uniform device and a illumination lens set, between the light source and the reflecting lens.

9. 10.The illumination apparatus for projection system according to Claim 5, wherein the imaging system includes a projection lens set and a screen behind the field lens.

10. 11.The illumination apparatus for projection system according to Claim 5, wherein the light valve is a DMD (Digital Micro-mirror Device).

11. 12.The illumination apparatus for projection system according to Claim 5, wherein the light valve is a TMA (Thin-film Micro-mirror Array).
